(19) United States
(12) Patent Application Publication
(10) Pub. No.: US 2018/0061274 A1
(43) Pub. Date: Mar. 1, 2018

(54) SYSTEMS AND METHODS FOR GENERATING AND DELIVERING TRAINING SCENARIOS

(71) Applicant: Gereon Frahling, Koln (DE)

(72) Inventor: Gereon Frahling, Koln (DE)

(21) Appl. No.: 15/249,400

(22) Filed: Aug. 27, 2016

(51) Int. Cl. G09B 19/06; G06N 99/00; G06F 17/27; G06F 17/21; G06F 17/28; G09B 5/06

(52) U.S. Cl. CPC G09B 19/06; G06N 99/005; G06F 17/2735; G09B 5/062; G06F 17/218; G06F 17/2795; G06F 17/289; G06F 17/2705

(57) ABSTRACT

The systems and methods discussed herein are employed to identify translation-challenged words in works including video, audio, text, and other works produced in a first language and generate language-learning scenarios in a second language. A dictionary corpus from a bilingual/multilingual dictionary may be analyzed to determine the translation-challenged words. Language-learning training scenarios are generated by augmenting the works with translations and/or other information associated with the translation-challenged terms to use for the language-learning scenarios, and may be delivered to a variety of device types. A library of language-learning training scenarios may be generated and updated as the bilingual/multilingual dictionaries are updated, the scenarios may be generated according to various difficulty levels, as the terms in the dictionary corpus may be associated with varying levels of difficulty, and terms above a particular difficulty score or within a score range may be specified for the generation of a particular scenario.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

As international recreational and business travel and ventures become more common in the global marketplace, there is a need for education on both the language and the customs of a variety of cultures. Language learning software may be used for students of varying ages, competencies, and goals, in order to facilitate communication between parties of multiple cultures.

### SUMMARY

In an embodiment, a system for generating and delivering an augmented media file, comprising: a server comprising a non-transitory memory, and a processor; an application stored on the server, wherein the application is in communication with a dictionary data store on a server, wherein the application, when executed by the processor: determine a plurality of translation-challenged terms by comparing a work to a plurality of terms in the dictionary data store, wherein the plurality of translation-challenged terms comprises single word and multi-word terms associated with a difficulty score above a predetermined minimum; and parse the work to determine where single word terms of the plurality of translation-challenged terms occur and where terms of the plurality of translation-challenged terms comprising at least two words occur in the work. The embodiment further comprising wherein the system tags at least one instance of each term from the subset of terms in the first work, wherein each tag comprises augmented information associated with the tagged term, wherein a first tag associated with a single word term of the plurality of translation-challenged terms comprises augmented information associated with the single word term; generates a training scenario comprising the work and the augmented information associated with the plurality of tagged terms; and transmits the training scenario for display.

In an embodiment, a method of generating and delivering an augmented media file, comprising: selecting, by an application stored in a non-transitory memory on a first server and executable by a processor, a video work from a plurality of video works stored on a second server based upon at least one characteristic of the request; tagging, by the application, a plurality of terms in the transcript, wherein the tagging a term of the plurality of terms comprises associating the term with augmented information, wherein the augmented information comprises a translation; mapping, by the application, the tagged terms in the transcript to the corresponding occurrence of the tagged terms in at least one of a voice-to text translation of the video work, an audio track of the video work, and the video, wherein, subsequent to mapping, the augmented information is displayed in a synchronized manner with the occurrence of the tagged terms in the video work; and transmitting, by the application, the training video, wherein the transmission comprises a display instruction.

In an alternate embodiment, a system for generating and delivering augmented media files, comprising: a server comprising a non-transitory memory, a processor; and a scenario-building application stored on the server, wherein the scenario-building application is in communication with a dictionary data store on a server, wherein the scenario-building application, when executed by the processor: identify a plurality of terms by comparing a work of a plurality of works to a plurality of terms stored in the dictionary data store, wherein the plurality of works comprises audio, video, text, and combinations thereof; determining, based upon a difficulty score associated with each term of the identified plurality of terms, a subset of the plurality of terms, wherein each term of the subset comprises a difficulty score that exceeds a predetermined minimum difficulty score; tags, in the first work, at least some occurrences of the terms of the subset of terms to associate augmented information with the at least some occurrences of the terms of the subset; generates a training scenario comprising the work, and associates the training scenario with a display instruction so that the augmented information associated with each tagged term displays at least one of simultaneously with the occurrence of the term and within a predetermined window of the occurrence of the term; and transmits the training scenario to a display device.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is an illustration of a system that may be employed in certain embodiments of the present disclosure to generate, store, transmit, and maintain language learning scenarios and user profiles.

FIG. 2 illustrates a system, an alternate embodiment of system configured to generate, store, transmit, and maintain language learning scenarios and user profiles according to embodiments of the present disclosure.

FIG. 3 is a flow chart that illustrates a method of generating and transmitting a training scenario according to embodiments of the present disclosure.

FIG. 4 is a flow chart that illustrates a method of generating training scenarios based on a request is illustrated by a flowchart according to embodiments of the present disclosure.

FIG. 5 is a flow chart that illustrates a method of generating a training scenario in the form of a video work according to embodiments of the present disclosure.

FIG. 6 is an illustration of a flow chart of a method of generating a training scenario based on a user profile according to embodiments of the present disclosure.

FIG. 7 is an illustration of an embodiment of a display of an e-book training scenario generated according to certain embodiments of the present disclosure according to embodiments of the present disclosure.

FIG. 8 is an illustration of a display of an audio book training scenario generated according to embodiments of the present disclosure.

FIG. 9 is an illustration of a display of a video work training scenario generated according to embodiments of the present disclosure.

FIG. 10 is an illustration of an embodiment of an e-book display of a training scenario generated according to certain embodiments of the present disclosure.

FIG. 11 is an illustration of a display of an audio book training scenario generated according to embodiments of the present disclosure.

FIG. 12 is an illustration of a display of a video work training scenario generated according to embodiments of the present disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

Foreign language movies, foreign language audiobooks, and books are some of the best media to learn a foreign language. One advantage is that the user can choose from an endless variety of content and use the content for language learning that is most interesting to the individual user. The content may comprise a plurality of works originally in or translated to a particular language that the user desires to learn or improve upon. For example, a user interested in Star Wars® can choose to watch a Star Wars® movie in a foreign language, the user interested in love stories can read a foreign love story novel. When the user selects the content, she stays motivated and the language learning is much more successful. However, the problem with conventional foreign language content is that it usually contains foreign language terms and phrases the user does not understand, e.g., that are translation-challenged. Conventionally, the content does not contain explanations or translation of the difficult foreign language terms, and the user has to interrupt the learning experience to look up the words or phrases in a bilingual dictionary. Some previously attempted solutions to this challenge are, for example, e-books where the e-book software gives the user the possibility to click on a word and look it up in a dictionary. But it still requires a user action to do so.

In contrast, the systems and methods discussed herein enables a user to choose foreign language content such as an e-book or a video work in their non-native language that was previously generated using a bilingual (words and phrases in 2 different languages) or multilingual (words and phrases in at least 3 different languages) dictionary. Each work may comprise a plurality of training scenarios, and in some embodiments a single work may be a single training scenario. A user can choose foreign language content in the language they desire to learn, the content (language-learning scenarios) may be generated at an initial level of difficulty which may be adjustable by the user manually or based upon a user profile. The language-learning scenarios are generated based on existing works and are augmented with a translation of translation-challenged terms and/or additional information. The merging of the translated work and the augmented information such as translations for terms in the work determined to be translation-challenged words gives the user the advantage of choosing content that covers the subject matter and language interests of the user. The systems and methods discussed herein provide the user the opportunity to consume foreign content like movies, audiobooks or books (of their choice), in its original language or in a translated version, but enriched (by the generation of a training scenario employing the chosen work) with translations of the most difficult words and phrases occurring in the media. This way, the user can consume the content of his choice without using an additional bilingual dictionary to look up the difficult words and phrases as they consume the content, and therefore without interrupting the language learning experience.

The influx and development of technology that enables media streaming and content download allows for the delivery of an enhanced language learning experience to a user or group of users. Users may be able to learn and practice foreign language skills using a multi-media approach on devices including personal computers, mobile computing devices, and wearable technology, by using multi-media language-learning training scenarios that may take the form of e-books, videos, web applications, widgets, audio books, and combinations thereof. In an embodiment, the training scenarios may be referred to as augmented media files. Through the use of these multi-media training scenarios, a user is provided a unique opportunity to learn and/or practice language skills by engaging with a training scenario configured based upon factors including the type of display device, delivery medium (e-book, video, audio), language, and/or language skill level. The training scenarios may employ different kinds of media in combination, such as audio, static pictures, video, and text tools, in order to create the multi-media learning experience. These training scenarios enable the user to learn terminology in an interactive environment, including learning what may be referred to herein as “translation-challenged” terms that may be considered challenging because they are rarely used, and/or due to spelling, pronunciation, dual meaning, cultural or era significance, or other factors. To enhance the learning experience and ultimate retention of these translation-challenged words, the training scenarios present information in various manners, aurally, visually, and in combination, to reinforce a term's meaning so that the user can understand, retain, and later use and understand the term.

Translation-challenged terms may be “observed translation-challenged terms” and/or “deduced translation-challenged terms.” Observed translation-challenged terms are those terms identified by systems monitoring real behavior (watching queries to dictionary, watching results of training sessions, etc). Deduced translation-challenged terms may comprise more basic definitions than observation-challenged terms where an expert categorizes the terms to a standard. Any term could be both, an expert could have marked it (deduced) and monitoring activity (observed) could have also caused it to be marked.

Translation-challenged terms are discussed in detail below, and may be presented and taught to the user by including information presented in multiple ways (audio, visual) in the training scenario. The information associated with the translation-challenged terms may be associated with those terms along with a tag that may trigger the audio and/or visual display of the information, or an option for the user to select that would promote the display of the information. Some users may be associated with profiles which may be created and updated based on a history of completed and attempted training scenarios and/or off of a user's self-evaluation or pre-test for a particular language. The display information may be triggered and therefore viewed by the user before, during, or after the presentation of the associated words, depending upon the embodiment including the display device, delivery method, and user preferences, including user preferences associated with a user's profile.

The training scenarios may employ information including translations, explanations, conjugation, pictures, video clips, definitions, audio recordings, synonyms, antonyms, example sentences, and other information associated with translation-challenged terms in order to assist the user in learning, remembering, and applying the terms. As noted above, this information may be presented to the user in various manners depending upon the display method and device on which the training scenario is viewed. For example, a training scenario generated for and displayed on an e-reader may comprise different types of information presentation than a training scenario generated for display on a laptop computer. In some training scenarios, this information may be displayed automatically as a user progresses through a training scenario, which may include the user electing to skip certain parts of a training scenario. In other embodiments, the user may be presented with the option to view the information as a training scenario progresses by clicking or swiping on an indication on the display, and may choose to view some, all, or none of this information. The user's device may collect and send information back to a server that generated and/or maintains the training scenario regarding what information was viewed/not viewed by the user, and/or how long the viewed information was viewed for.

One opportunity presented by the present disclosure is a suite of automated systems or tools working together to create and support the above features on a wide variety of media. Identification of translation-challenged terms may be dynamically completed or augmented through computer analysis of information stored in an online multilingual dictionary, as well as through computer analysis of user interactions with the training scenarios themselves. The multilingual dictionary may be a bilingual dictionary or may comprise translations of terms between three or more languages, and may be referred to herein as a “dictionary,” which is understood to mean a data file comprising a plurality of terms translated from a first language into at least one other language. This should be distinguished from a conventional dictionary as used in at least the U.S. which comprises words in a single language and information about those words and phrases. This type of single language dictionary may comprise an origin language (e.g., Latin) of a term in a first language, but does not comprise a translation to another language. As used herein, the term “dictionary” with respect to a physical book, data store, or application, refers to that entity in the context of at least a bilingual and in some embodiments a multilingual dictionary. Scenario-building systems can be run on various media works where the work and a translation are available to leverage the identified translation-challenged terms, and combine those with user profile information and potentially other user input or requests to automatically identify matching terms in a translated work and then augment the media of the work to highlight or augment the terms in the work to create a teaching tool. In embodiments augmenting video or audio media, in addition to identifying and augmenting terms, a technique of using computer speech-to-text may be used to create an initial mapping of a previously non-augmented video work identifying marker points within the soundtrack against even a rudimentary transcription. A more detailed and accurate transcript which has not been synchronized may be used to develop the terms to augment. Then the overlaps between the voice to text translation and the more accurate transcript may be used to guide the synchronization of the more accurate transcript to the soundtrack so the augmentations appear in a more tightly defined time space in the media.

In more detail, the training scenarios discussed herein are generated automatically and in response to requests for training scenarios received by the system by a system administrator, user, or other authorized party, and later retrieved by the user based upon their desired content and language. As discussed herein, a request to generate a training scenario may come from a system administrator, or may be generated dynamically on a predetermined schedule as a part of a development of a training scenario library across multiple disciplines and languages. In alternate embodiments, a user may request the generation and/or retrieval of a training scenario that was previously generated, but it is appreciated herein that requests to generate training scenarios are not necessarily from users/students.

In some embodiments, the training scenarios may also be generated and/or selected from previously generated scenarios based upon information associated with user profiles (such as a history of training), or based on parameters that may be found in user profiles but may not be associated with a specific profile, such as a. These training scenarios may be stored and catalogued after generation and/or transmission for later retrieval and use for subsequent requests. An application or applications working in concert to automatically build the training scenarios may be configured to communicate with a dictionary application and/or a dictionary data store as well as other systems in order to identify translation-challenged terms in a work. The “dictionary data store” discussed herein may comprise a bilingual or a multilingual data store, in contrast with a conventional single-language dictionary. The application may comprise multiple modules and be executable by a processor, and may be stored on a server separate from that where the dictionary application and data store reside, or may be stored on the same server.

In a step in one embodiment, the application may compare the translation-challenged terms from the dictionary data store to a work selected based upon the request and/or user profile. The application additionally may compare the text or a translation of a text of a work to the dictionary data store to determine the translation-challenged terms. This determination may be based upon an at least one attribute including a difficulty score, where a work is compared to the dictionary data store by the application and any terms occurring in the work that are present in the dictionary data store and associated with a difficulty rating above a predetermined minimum, below a predetermined maximum, or within a predetermined range. In some embodiments, the application may retrieve from the dictionary data store a first plurality of terms present in the work and then the application may determine what subset of those terms comprise a difficulty score above the predetermined minimum or within the predetermined range and this subset of terms may be referred to as “translation-challenged” terms.

In alternate embodiments, the application may retrieve from the dictionary data store a first plurality of terms present in the work and then determine, for example by way of an iterative process, what terms in the subset are employed alone and which are employed in phrases. In one example, if the subset of translation-challenged terms comprises the terms “programming,” “language,” and “programming language.” The application may determine where incidents of a single-word term occur in the absence of the occurrence of other terms, that is, where translation-challenged terms comprising single words are used and tagging those separately from where translation-challenged terms comprising one or more words occur. In this embodiment, the partial sentences “a programming expert” and “the programming language” would be tagged differently, the first comprising a tag with a translation or other augmented information associated with “programming” and the second comprising a tag with a translation or other augmented information associated with “programming language.” This iterative process separates single-word translation-challenged terms from multi-word translation-challenged terms so that the correct translations are associated with the tagged terms and so that there is no confusing overlap between tags, that is, so that “programming language” is tagged once with the translation for the whole term and not tagged three times for “programming,” “language,” and “programming language.”

The application tags the terms identified in the work as translation-challenged terms. This tagging may occur in at least two of an audio track, voice-to-text transcription, transcript, and video track, and may comprise associating translation-challenged terms with augmented information including the translation of the translation-challenged terms into at least one language wherein a translation-challenged term is presented in a native language or a learned language of a user simultaneously with a translation of the term into the language of the work in the language-learning scenario. The tags may serve a plurality of purposes, including acting as a trigger for displaying or giving the user the option to display augmented information about a translation-challenged term before, during, or after the occurrence of the term in the work.

In another step in the embodiment, after tagging, the application maps the tagged terms in the at least two of an audio track, voice-to-text transcription, transcript, and video track associated with the work, and synchronizes the at least two of the audio track, voice-to-text transcription, transcript, and video track, so that the display and presentation of the translation-challenged terms and/or the associated augmented information is similar to a normal viewing experience, e.g., so that there is not an unintended lag between audio/video, audio/text, or text/video that would hinder or unintentionally disrupt the learning experience. In some embodiments, there may be an intentional lag introduced between the occurrence of the translation-challenged term and the display/presentation of the associated translation and/or other augmented information. In alternate embodiment, a translation may be displayed prior to the occurrence of the term or terms.

In other embodiments, synchronization between the occurrence and the presentation may be desired. In this embodiment, the lag time is diminished, reduced, or otherwise modified so that the user experiences a synchronized occurrence of the term and the presentation of the translation and/or other augmented information. That is, a video training scenario has the video track synched with the audio track and/or with a text transcript so that the user is presented with the translation-challenged term(s) and augmented information or option to display that information within a predetermined window of the occurrence of the terms in the video. A “window,” as used herein in any type of scenario (e-book, video, audio, etc.) refers to a time period, a number of pages, or another measurement or combination of measurements that may be employed to coordinate the display of information to a user. In an alternative to this approach, the voice to text transcription may not be tagged for translation-challenged terms, but may instead simply be mapped by all or a sample of the terms appearing in it to specific times in the media and then matched to available matching segments of the accurate transcript. Once the accurate transcript as a whole is synchronized by use of the voice-to-text transcription, the translation-challenged terms in the accurate transcript will be synchronized to the media itself to allow for more effective augmentation.

In an e-book example, the display or option to display augmented information in an e-book is presented when a translation-challenged term is presented on the page, and in a location that may correspond to the location of the term on the page. In a different example, the augmented information may be presented within a predetermined window of the appearance of the terms in the audio book or movie. In some embodiments, this predetermined window may be within a few milliseconds of the display of the word, and in alternate embodiments it may comprise a time period prior to the start of a chapter or scene. The display of the training scenario may be associated with a display instruction transmitted to an application on a display device separate from or as a part of the training scenario. It is appreciated that the application that generates the training scenario may transmit it to the display device by any known method of transmission, including a cellular network, Wi-Fi, LTE, link to a web portal, Bluetooth, or other known methods of transmitting media and/or access to media via both wired and wireless connections. The application on the display device that receives the training scenario may also be configured to collect and report information regarding the receipt and progress on the training scenario back to the application that generated the training scenario, and in some embodiments a user profile may be updated based upon at least one of the generation, transmission, and feedback received about the training scenario. The automated process of identification and tagging of translation-challenged terms, mapping, synchronization, and ultimate transmission of the training scenario occurs without user intervention in order to create a seamless learning experience for the user.

Once the scenario generation including term tagging, synchronization, and augmentation is complete, in one example, a resulting video training scenario is transmitted to a native English speaker for an enhanced language-learning experience in German. This video training scenario may be an action movie that was originally made in or has been translated to German, contains a German audio track, and may display difficult (translation-challenged) German terms used in the action movie with the corresponding English translation. The audio and visual displays of information are synchronized as discussed below so that the German text corresponding to the audio of the action movie may be displayed as the movie progresses, for example, as a subtitle, when the audio is played. The synchronization also enables information associated with translation-challenged terms to be displayed before, during, or after the word is used in the action movie. In some embodiments, the German text or may not be displayed during the viewing of the movie, depending upon a user preference, but the user may still receive a pop-up or other indication as to when a translation-challenged term may be used even if the subtitles are otherwise turned off. This indication may be displayed in response to a trigger associated with a term such as a translation-challenged term that was tagged in at least one of the voice-to-text transcription, transcript, audio track, and/or video track of the action movie during the generation of the training scenario. When an indication is displayed, the user may elect to view information by interacting (clicking, swiping) with the indication. The user is able to progress through the action movie, in whole or in part, and the translation-challenged terms may be presented along with the display and recitation of the object of the translation-challenged word. In one example, if the action movie uses the term “Seilbahn,” the English translation of this term (which means a zip line) and information associated with the term may be displayed or the user may be presented with the option to display the information on the screen when the zip line appears on the screen. Thus, the movie plays a German audio track and shows English translations of German terms for native (or otherwise proficient) English speakers learning German. The user has the option to pause the movie to review the translation and/or the additional information during this enhanced learning experience.

In some embodiments, the training scenario for an action movie with a Spanish audio track may comprise a Spanish language lesson prior to starting the action movie that shows some or all of the translation-challenged terms that occur in the movie as well as their English translations. In other examples, the training scenario may break or pause the movie without user intervention in order to display information, or may present the user with an option to display information about upcoming translation-challenged terms prior to the occurrence of those terms in the video work. This information may comprise translations and explanations, how the word sounds, meanings in multiple languages including English and Spanish and the user's primary and/or secondary language, illustrations associated with the term, and/or other information to assist the user in learning, remembering, and applying the translation-challenged term. If a mace (“maza”) is mentioned in the Spanish audio track of the action movie, the English term “mace” may be displayed at the same time that the term “maza” is discussed/mentioned in the video, along with an indication that additional information is available for viewing if the user so chooses. This may be done through synchronization of the movie's audio track and transcript so that the term and translation of “maza” are displayed in response to the tagging of the term when the term is discussed in the movie. Using this action movie training scenario, the user's learning and understanding of terms is reinforced by the display of definitions and/or additional information associated with the term in order to enhance the user's ability to learn, understand, and subsequently use and identify the word at other points in the training scenario and/or in other contexts so that, for example, when they hear the term “maza” later in the movie or read it in a literary work they are able to recognize the Spanish term.

In another example, a non-native French speaker may elect to improve their French language skills by reading an e-book in French. The e-book training scenario may comprise an audio track mapped to the text of the e-book, for example, by way of a voice-to-text transcription and/or a transcript. In some training scenarios, a plurality of information about some terms may be displayed before the e-book's text is displayed, for example, in between chapters or other segments. In other training scenarios, the user may be presented with an option to view this information while they are reading the e-book, for example, if a translation-challenged term appears on a page, the term's translation and/or other information may also be displayed. The e-book training scenario may comprise a plurality of viewing panels, where a first viewing panel comprises the text of the e-book, and an adjacent, collapsible, second panel comprises information about some of the terms displayed in the first panel during the display of those terms. This information may comprise translations into multiple languages, and in some embodiments, definitions, pronunciations (audio), terms associated with the tagged term, or other information that may enable the user's understanding of the term. In some embodiments, if multiple tagged terms are displayed in the first panel, the second panel may display information associated with more than one tagged term.

If a user employs an audio book training scenario to learn or practice foreign language skills, additional learning options may be available to enhance the user's experience. For example, the audio book training scenario may provide an interactive section in a first panel of the display device's screen (graphical user interface, “GUI”) that enables the user to stop, start, pause, and perform other functions with respect to the progress of the training scenario. A second panel may be adjacent to the first panel, and may be employed to display a plurality of information for terms that may be presented to the user in the first panel. Thus, the user can both read text and listen to audio simultaneously. In an embodiment, these terms may be translation-challenged terms, and the information associated with the terms may be displayed in the second panel: (1) before the term is heard by the user, but without pausing the audio, (2) during a break in the audio, prior to or subsequent to a recitation of the term, and/or (3) before the term is heard by the user and while the audio is paused, which may be prior to starting the audio book and/or a particular section of the audio book. The user is thereby able to use the visual cues in the second panel that comprise the information in order to enhance their learning, retention, and use of the translation-challenged terms along with the rest of the text.

Learning foreign languages for business or recreational travel purposes may be a challenge on several fronts, including what may referred to herein as learning a language that includes “translation-challenged” words and phrases, which may be collectively referred to herein as “translation-challenged terms.” Using the systems and methods discussed herein, a plurality of training scenarios may be generated for individual or groups of users in order to teach students aspects of language that extend into science and technology, historical events, and other such aspects of foreign cultures that conventional language-learning systems methods may not encompass.

As discussed herein, a “language-learning scenario” or a “training scenario” may be the term used to describe all or part of an audio work, video work, or e-book, including electronic copies of books that may not have been formatted to be e-books, that comprises the original work or a translation of an original work, including augmented information. As used herein, the term “translation-challenged” may be used to describe infrequently used (rare) terms, e.g. those terms that a user who wants to learn French may not see widely used across various texts and video works. In some embodiments, translation-challenged terms may also refer to terms that are technical in nature (engineering/science terms), colloquialisms, words that sound the same but have different meanings, words that are spelled the same but pronounced differently and/or have different meanings, words that are spelled differently but have the same meaning, culturally-specific words, and historically-significant words. Translation-challenged terms may, in some embodiments, further comprise other words and phrases that may be harder to translate between particular languages, or those terms have a tendency to be translated incompletely or incorrectly than surrounding text in a work. In an alternate embodiment, the term “translation-challenged” may also be used to describe terms that are conjugated differently than other verbs in a particular language, as well as proper nouns and proper nouns that may have had previous meaning or association (e.g., Istanbul was formerly named Constantinople, the former existence of East and West Germany, etc.). In some embodiments, the term “translation-challenged” may also be used as discussed below to describe words based upon tags and/or difficulty scores associated with terms stored in a dictionary data store. These tags and/or difficulty scores may be determined by an analysis of the frequency of requests and/or searches of the dictionary for a term or terms, where terms more frequently searched for may receive higher difficulty scores because the more frequent searches may indicate that more users have trouble with the translation. In alternate embodiments, terms that are not frequently searched for may receive higher difficulty scores because the terms may not appear in works enough to be searched. In addition, the term “work,” as used herein to describe the basis from which training scenarios are generated may comprise a printed publication, a video, an electronic publication including articles and e-books, or an audio recording.

In an embodiment, translation-challenged terms in a dictionary data store are determined based upon what may be referred to as a “corpus analysis” across multilingual texts, including dictionaries and literary works as well as video, e-book, and other works. These words may also be manually flagged within the dictionary data store. The corpus is analyzed to determine the occurrence of translations, that is, the translations seldom used across the corpus are determined, and translations that occur rarely may be marked as translation-challenged terms, and/or may be assigned a relative score that is later analyzed to determine and assign a difficulty score. In an alternate embodiment, the frequencies of monolingual terms or phrases may be computed by counting the phrases in a monolingual corpus. The frequency of a translation in a bilingual corpus is highly correlated to the probability that the user knows the translation. The more frequently a translation occurs in real life (e.g., as represented in the corpus), the more probable that the user has already seen this translation multiple times, so the term may be assigned a lower or 0 difficulty score as compared to the difficulty score assigned to the most infrequent translations in light of the corpus analysis. The assigned difficulty score may be stored along with the term in the dictionary data store and may be used during tagging.

It is appreciated that the works used as the basis for generating the training scenarios discussed herein may be authorized copies of master works. Once a training scenario is generated according to embodiments of the present disclosure, the training scenario may be stored in a data store as discussed herein, and associated with a plurality of attributes—language of original work, translation language, level of difficulty, concentration of translation-challenged words (overall or by segments as discussed herein), time range for execution/completion, successful completion rate, average time to completion, and other attributes of the training scenario including display method and/or devices to which the training scenario can be submitted (e.g., a training scenario for a video work may not be able to be played on an e-reader). In an embodiment, a first training scenario may be associated with other training scenarios that have been used and/or successfully completed by users who also completed the first training scenario. This association may be used to generate recommendations and/or a training plan for users and/or groups of various skill levels and with a plurality of language-learning goals. In alternate embodiments, the user may select a particular work and language of the work, and may tailor the difficulty level based upon a base difficulty established for the training scenario. In this embodiments, the user may adjust a difficulty rating or use a sliding bar (scale) to increase the difficulty, which may comprise displaying tagged terms that were associated with a higher minimum difficulty score or within a more narrow range of scores than present in the totality of the tagged terms.

Thus, a single language-learning training scenario may be generated where a first plurality of translation-challenged terms is tagged, and this may comprise a training scenario for a beginning student who wants to learn German. Each translation-challenged term, as discussed above, is associated with a difficulty score in either the dictionary data store, during the tagging process, or both, and in some embodiments the difficulty score is taken from the dictionary data store for a translation-challenged term and associated with the term during tagging. When a training scenario contains these values associated with each translation-challenged term, it is essentially a training scenario for all language levels: If it is too easy for a user, she can choose to only see the terms having a difficulty score above a certain threshold. She will then see fewer terms (only the most difficult or most challenging ones, depending upon the difficulty score range or minimum selected by the user), and is less interrupted in her consumption of the media. As such, a single scenario is generated for a range of user skill levels and thus provides the user the opportunity to choose her language level in real time when she is consuming the media. In one embodiment, the selection may be performed by way of the user interface which may present a slider and/or manual entry fields. If the user sets the slider to “difficult”, he sees very few explanations and is less interrupted. If he sets the slider to “easy”, he will be interrupted more frequently, or see information for more and easier terms. This can be done in real time by the display device, since the training scenario contains all information needed (the difficulty score for each term).

In an embodiment, the plurality of display methods may be specific to a device type (e-reader, tablet, mobile phone, PC, etc.), an operating system, a network connection type (cellular, Wi-Fi, etc.), as well as to the type of work and may also be based upon preferences in the user profile. Examples of display methods include: showing the translation-challenged terms and augmented information on an e-book in a column adjacent to the text of the work, playing an audio of the translation-challenged term and augmented information, or combinations thereof. Depending upon the embodiment, the augmented information may be shown in a synchronized manner with the display of text/video or sound of audio, or may be shown before a segment starts, after a segment ends, before a translation-challenged term is displayed, after a translation-challenged term is displayed, while a training scenario is paused, or combinations thereof depending upon the display device, training scenario configuration, and predicate work type (audio, video, e-book, etc.).

In an embodiment, a dictionary application may be in communication with a dictionary data store. This dictionary data store may comprise a plurality of terms translated across a plurality of languages, augmented information associated with at least some of those terms, as well as a plurality of information associated with queries received by the dictionary application. This information may be collectively referred to herein as “augmented” information, since it augments the learning experience of students looking up those words. In an embodiment, the dictionary application is configured to not only receive queries for terms and phrases across the plurality of languages, but is further configured to store and analyze the queries for a variety of purposes, including to identify what words may be considered to be “translation-challenged,” as discussed below.

In an embodiment, the augmented information may be information associated with a term, including translations into at least one language, synonyms, antonyms, related words (including plurals and gender-specific words), verb conjugation (including gender/object specific terms), use cases, history of terms/phrases, graphics, videos, country or culture of origin (or multiple), primary field of use, cultural significance of terms/phrases, and other information in addition to a translation of the term into at least one other language. The augmented information associated with translation-challenged words may comprise one or more pieces of information and may be associated with one or more languages. For example, the phrase “sore loser” may be an entry in the dictionary data store, and may comprise augmented information including translations in at least one language of “sore” and “loser” as well as a definition of the individual words and phrase and a translation of the phrase itself and an example of the phrase's used in a sentence. The data store may comprise additional information indicating whether this term has been tagged as “translation-challenged” in addition to a plurality of information associated with queries for that term and/or related terms.

In some embodiments, the number of times and/or the frequency (number of searches/interval of time) of queries submitted for various terms, terms searched together, or other information received and stored by the dictionary application in the dictionary data store may be employed to determine which words are translation-challenged. For example, using the dictionary data store and/or the dictionary application, translation-challenged terms may be determined by (1) analyzing what queries are received by the dictionary to determine the frequency of searches and text strings of searches as well as sequential searches, (2) analyzing what received queries were not successfully answered by the application (e.g., what were users looking for that was not in the dictionary), and (3) user or system-created tags on a term, which may also be employed to map translated-challenged words and phrases to various works. In an embodiment, the dictionary data store comprises an indication for some terms that may be a tag that indicates (1) if a term is translation-challenged and (2) at least one language in which the word is translation-challenged. In addition to a difficulty score determined as discussed above as a part of the corpus analysis, and in some embodiments, due to the differences between Latin-based languages and other languages, or due to conflicting meanings between cultures, some words may translate more easily from language A to B than from language B to C, and the dictionary data store may comprise an indication of what translations (between which languages) are translation-challenged. This may be useful, for example, if a user fluent in German and French is trying to learn Spanish, and may therefore be able to see both the French and German translation of a translation-challenged word in a Spanish language-learning scenario.

In an embodiment, a training scenario may be dynamically generated in response to a request, or may be stored based upon previous user or administrator requests and retrieved when a request is received by the application. When a training scenario is generated, one or more pieces of augmented information may be associated with the translation-challenged terms in the work. For example, the first instance of each translation-challenged term within the work or within a segment of the work that is less than the entire work may be tagged as translation-challenged and associated with augmented information. In some embodiments, there are various triggers associated with the tag that trigger the display of the translation-challenged word and/or the associated augmented information.

The training scenarios discussed herein may be user-dependent or user-independent. For example, a user-independent training scenario may be generated in response to a request for a documentary in French. This documentary may be specifically requested, or may be randomly selected by a scenario-generated application, or may be selected by the application based upon attributes associated with the documentary such as a level of difficulty, users ratings' or success/progress from previous trainings, or other factors that are not dependent on the requestor's profile, but that may be selected based on inputs such as language, genre, era, author, etc. In contrast, a user-dependent training scenario may be one generated based upon either a request from a user to generate a scenario in a particular language and in some embodiments the user may also specify an era, an actor, a director, an author, a publisher, a related work, a producer, a screenwriter, a vocal artist, a title, a category type, a subject type, a genre, a cultural affiliation, or combinations thereof. In the user-dependent embodiment, the application receives a request from the user that includes inputs as discussed above, and selects and generates the scenario not only based upon the request's inputs, but based upon at least some of a plurality of information associated with the user profile associated with the request. In an embodiment, a data store accessible by the scenario-building application, which may be the same data store as the dictionary data store or which may be different, comprises a plurality of user profiles. Each user profile may comprise a plurality of current skill levels, including skill levels for different languages, genres of works, categories, etc., as well as a plurality of desired skill levels, a native language, and a plurality of subject matter skill levels, where a subject matter skill level may comprise sub-levels for different languages. The plurality of desired skill levels may be set by the user or by a user's supervisor or a system administrator. These desired and current skill levels may be language-specific and associated with a sub-category such as subject matter, genre, category, or other areas where a user would desire specific knowledge. In an embodiment, a user may self-designate their proficiency level for various languages, and in alternate embodiments the user may take a diagnostic training scenario in order to determine a current language skill level for a particular language. In an alternate embodiment, the current skill level may be assigned by a supervisor or by the application based upon an analysis of a user's past performance on training scenarios. In any of these embodiments, the user's current skill level may be revised in an iterative manner, for example, as training scenarios are attempted and/or completed.

In one example, a PhD chemist working for a company based in country X may set a desired skill level for language X, and specify different desired skill levels for history and fiction than for chemistry-based subject matter. Each desired skill level for each language may also be defined by at least one of a category, language, genre, subject matter, or combinations thereof. In this embodiment, the chemist's profile may comprise a high desired proficiency level in chemistry across more than one language. A proficiency level may be defined as the ability of a user to function conversationally while traveling, socially, in a business setting, or in a technical business setting (engineer/science). In some embodiments, the user profile further comprises viewed training scenarios, completed training scenarios, and related training scenarios. In some embodiments, the user profile further comprises at least one sub-category associated with each language skill level of the plurality of language skill levels, wherein the at least one sub-category comprises an era, a genre, a subject category, a desired skill level for a language, a desired skill level for a sub-category.

### EXAMPLES

Training scenarios may be generated in various manners, some embodiments of which are illustrated by the examples below.

### Example 1

In an embodiment, an application analyzes a voice-to-text transcription or a transcript of a work. This analysis may be in response to a request to generate and transmit a training scenario. The application may analyze the work, comparing the words and phrases in the work to tagged terms in the dictionary data store. The application may determine which terms are translation-challenged based upon difficulty scores associated with terms in the dictionary data store determined based upon a corpus analysis as discussed herein. In this example, terms in the work that are the same as or substantially similar to the terms determined to be translation-challenged, and at least a portion of the augmented information associated with those tagged terms (e.g., at least the translation) may be associated with the term(s) at least at the first occurrence of each term in the work or in a segment of a work. As discussed herein, the terms may be tagged iteratively, where the application determines when single-word translation-challenged terms occur in isolation and when they occur in combination with another word or word to constitute a phrase that has also been identified as a translation-challenged term.

In some embodiments, segmentation of works may occur, for example, if the work gets progressively more complicated (e.g., a textbook) and/or based upon the length of the work as well as, in some embodiments, profile information that may be associated with the request. In embodiments where segmentation of a work occurs, this may be done automatically using preset parameters comprising number of terms, length of a video, concentration of translation-challenged terms, profile information if a profile is associated with the translation request, combinations thereof, and other factors as discussed herein. A training scenario may be generated and comprise the work (which is a copy or reproduction of the work made from an authorized copy of the work that may be stored in a server as discussed herein) as well as the tagged terms and augmented information from the multilingual dictionary. In some embodiments, a voice-to-text transcription or a text transcript may be combined, for example, with a video work, or an audio track combined with a text work, to generate the training scenario. The training scenario, when generated, may be transmitted by the server to a device as discussed in detail herein, and may further comprise an instruction as to the method of display. The method of display may be based upon the profile associated with the request, the type of work, and/or the device to which the training scenario is transmitted.

### Example 2

In another example, a training scenario may be generated based on an input that may be used in a user profile. In some examples, a user who may be associated with a profile requests a training scenario in the form of a video work. In other examples, an input or a plurality of inputs that may be associated with one or more user profiles may be used to generate the scenario, and the request may comprise a plurality of inputs as discussed above. In this embodiment, the inputs may specify the name of a particular work, or a genre/type of work and translation language, or combinations thereof. The application may retrieve a corresponding training scenario automatically generated using an existing video work based upon a dictionary comparison and corpus analysis as discussed above, determine and tag a plurality of translation-challenged terms. In this example, however, the tagging may be done in a voice-to-text transcription of the video work, in a transcript of the video work, and/or in an audio track of the video work, and the augmented information may be inserted as discussed above. The video work and tagged transcript, voice-to-text transcription, and/or audio track may be synched to generate the training scenario, which may be transmitted for display as discussed above. This synchronization may comprise mapping tagged terms in an audio track, voice-to-text transcription and/or transcript to the occurrence(s) of those terms in the video work so that information associated with those tagged terms may be displayed before, during, or after the occurrence(s) of the word in the video work. When the training scenario is generated and stored, a user requesting a training scenario that has been previously generated may use inputs such as those discussed above to retrieve the training scenario because the training scenario is associated with the inputs submitted.

### Example 3

In another example, the application may receive a request to generate a scenario, and the request may be associated with a profile as discussed above. The application may present a user training scenarios for selection that were previously automatically generated based upon the inputs received in the request as well as profile information such as the user's primary language, desired skill level in another language, and previous completions (or lack of completion) of other training scenarios. The application may determine if a training scenario was previously generated that meets the profile and request inputs, and if there is no such training scenario, the application may generate one and/or modify an existing training scenario as appropriate or send a notification to an administrator regarding the request and the lack of a suitable training scenario. In an embodiment, the application selects the work and may map translation-challenged words to an associated transcript and/or audio and/or voice-to-text transcription depending upon the work, and then tag the words with augmented information. The components (transcript, audio recording, voice-to-text transcription) may be synched with the work to generate a training scenario. As discussed above, a display instruction may be included in or transmitted with the training scenario to a display device. In some embodiments, a training scenario may be assigned a unique identifier for retriever, association with other training scenarios, and progress/success tracking.

In an embodiment, a training scenario may present a test to the user at the end of the scenario, or may present test questions to the user during the scenario. If a user does not answer correctly, or does not answer a predetermined number or percentage of questions presented on the test, the user may receive a notification as such. In this embodiment, the display device is in communication with the application and transmits a plurality of information to the application, this plurality of information may comprise progress by the user, successful completion, unsuccessful completion (failed tests, incomplete progress), as well as a plurality of user-input ratings regarding the ease of use and overall user experience, as well as data associated with the time spend on the training scenario and the time spent on the translation-challenged words. The profile associated with the request may be updated with this information and other information, and the updated information may be used for future requests from the user and from other users to determine future training scenarios to retrieve/generate. For example, if a user executes a training scenario at a first level of difficulty and successfully completes the associated test, the user's profile may be updated to indicate that future training scenarios at a higher level of difficulty may be appropriate. Conversely, if a user executes a training scenario at a first level of difficulty and does not successfully complete the associated test, the user's profile may be updated to indicate that future training scenarios at the same level or at a lower level of difficulty may be appropriate. The tests may be presented in the form of multiple choice, fill in the blank, or other known form of testing, and the questions/answers may be presented/received through manual inputs or voice inputs, or both.

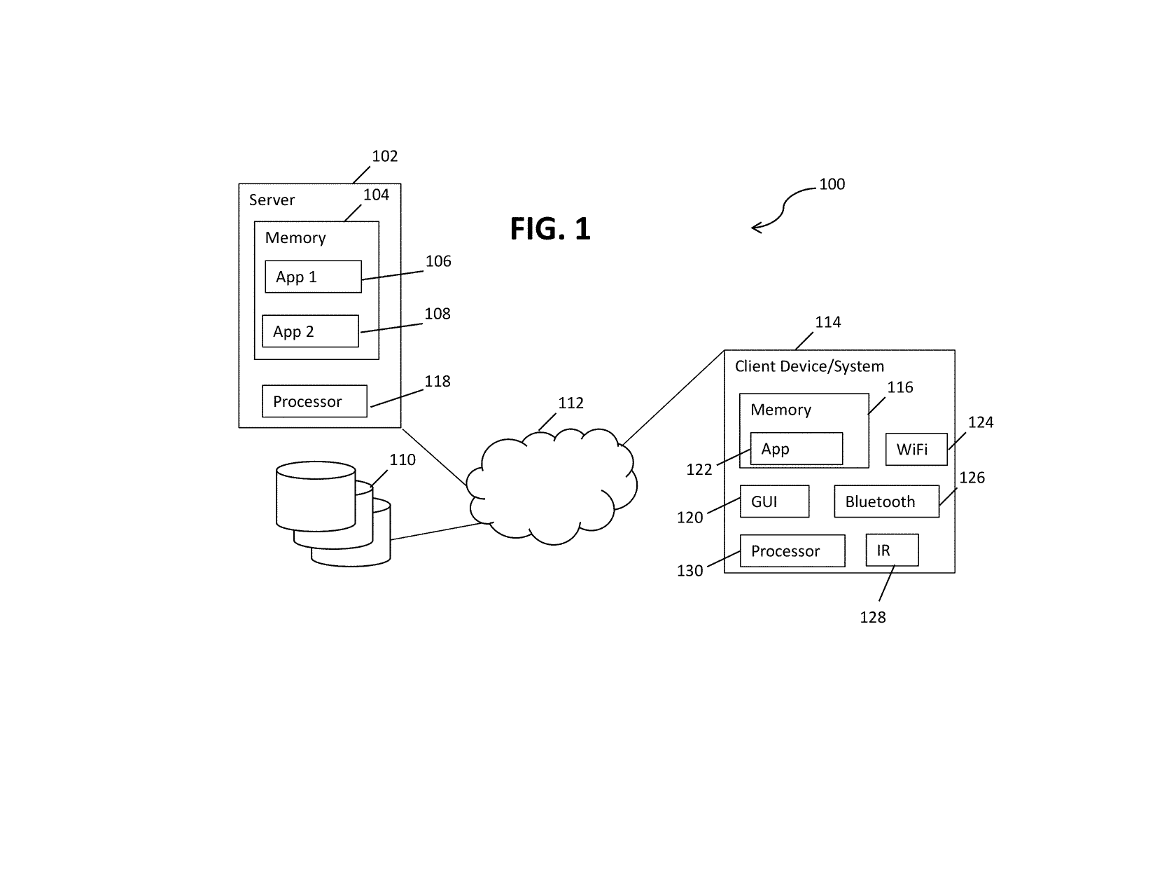

FIG. 1 is an illustration of a system 100 that may be employed in certain embodiments of the present disclosure to generate, store, transmit, and maintain language learning scenarios and user profiles. In an embodiment of the system 100, a server 102 may comprise a non-transitory memory 104 which may comprise a plurality of memory partitions (not pictured). A first application 106, which may be referred to as a scenario-building application 106 or a scenario application 106 may be stored in the memory 104. A second application 108 may also be stored in the memory 104, this application may be referred to as a dictionary application 108. Both applications 106 and 108 may be executable by a processor 118, and may be in communication with some or all of a plurality of data stores 110. At least one of the data stores of the plurality of data stores 110 may be a dictionary data store. The dictionary data store may comprise a plurality of terms (words and phrases) in at least two languages each, e.g., it is at a minimum a bilingual dictionary data store and may be a multi-lingual data store. In some embodiments, the data store may further comprise difficulty scores associated with some or all of the terms, as well as linkages between the terms between languages/translations, these linkages are used for generating translations for the tagging discussed herein. In some embodiments, the translation(s) may be referred to as augmented information. In alternate embodiments, the augmented information may further comprise pictures, video clips, definitions, audio recordings, synonyms, antonyms, example sentences, and other information associated with terms and intended to assist the user in learning, remembering, and applying the terms in contexts such as e-books, videos, and audio recordings (audio books).

In an embodiment, the server 102 may be in communication with a plurality of other servers, systems, and devices, by way of a network 112 and/or through wireless, near-field (NFC), Bluetooth, or other communication mechanisms. For example, a device 114 which may be a portable or stationary electronic device, including a wearable device, may comprise a memory 116, a graphic user interface (GUI) 120, hardware and software to configure communication over WiFi 124, Bluetooth 126, and/or infrared 128 means, as well as an application 122 executable by a processor 130. In some embodiments, other wireless networks may be employed, including general packet radio service (GPRS), enhanced data rates for GSM evolution (EDGE), long term evolution (LTE), and others as employed in the art to establish wireless communication. The application 122 may be configured to receive and execute training scenarios received from the scenario-building application 106, and to transmit data regarding the receipt and execution, including progress and completion of a received training scenario, back to the scenario-building application 106.

In an embodiment, the scenario application 106 automatically generates language-learning training scenarios by comparing a work to the dictionary data store 110 and determining which terms present in the work are present in the dictionary data store 110 and associated with a difficulty score above a predetermined minimum or within a predetermined range. These may be considered translation-challenged terms and may be tagged with a translation into at least one other language and/or other augmented information. In one example a German scenario intended for native or fluent French speakers may have German translation-challenged terms tagged with the French translation. The training scenario generated comprises tagging of all translation-challenged terms that comprise a difficulty score above the predetermined minimum or within the predetermined range, this training scenario may be categorized as a “base” or “easy” scenario, and the difficulty may be adjusted manually by the user or automatically in response to an attribute of a user profile. The scenario application 106 configures each base scenario to where the scenario's difficulty can be adjusted on the display device 114 without being sent back to the server 102 in that the scenario receives the difficulty adjustment as a modification to at least one of which tagged translation-challenged terms are displayed and the frequency with which the translations are displayed for a particular tagged term. That is, a more difficult scenario may only display the augmented information (translation) for a first occurrence of a translation-challenged term, in comparison to a scenario with easier difficulty which may display the first occurrence as well as subsequent occurrences, up to all occurrences of a translation-challenged term. In some embodiments, translation-challenged terms associated with a difficulty score that meets or exceeds a predetermined minimum are tagged.

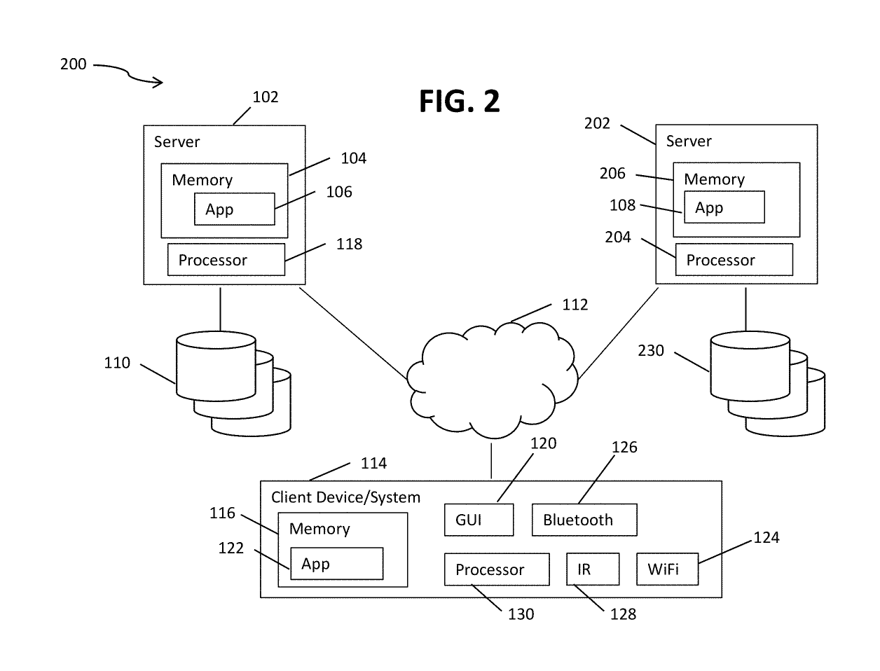

FIG. 2 illustrates a system 200, an alternate embodiment of the system 100 configured to generate, store, transmit, and maintain language learning scenarios and user profiles. The system 200 may comprise a server 102 and a device 114, similar to those in FIG. 1. The device 114 may be a portable or stationary electronic device, including a wearable device, may comprise a memory 116, a graphic user interface (GUI) 120, hardware and software to configure communication over WiFi 124, Bluetooth 126, and/or infrared 128 means, as well as an application 122 executable by a processor 130. The application 122 may be configured to receive and execute training scenarios received from the scenario-building application 106, and to transmit data regarding the receipt and execution, including progress and completion of a received training scenario, back to the scenario-building application 106. The server 102 may comprise a memory 104 where a scenario-building application 106 is stored, and the server 102 may be in communication with a plurality of data stores 110.

In addition, the application 106 may be executable by a processor 118, similar to system 100 in FIG. 1, but in the system 200, the dictionary application 108 may be stored on a second server 202 in a memory 206, and may be executable by a processor 204. In this embodiment, the dictionary data store may be one of a plurality of data stores 230 accessible by the dictionary application 108 and, in some embodiments, by the scenario-building application 106 as well. Thus, either of the systems 100 and 200, the scenario-building application 106 may directly query (request from) the dictionary data store of the plurality of data stores 110 to obtain information as discussed below, or the scenario-building application 106 may cause the dictionary application 108 to query and return information from the dictionary data store.

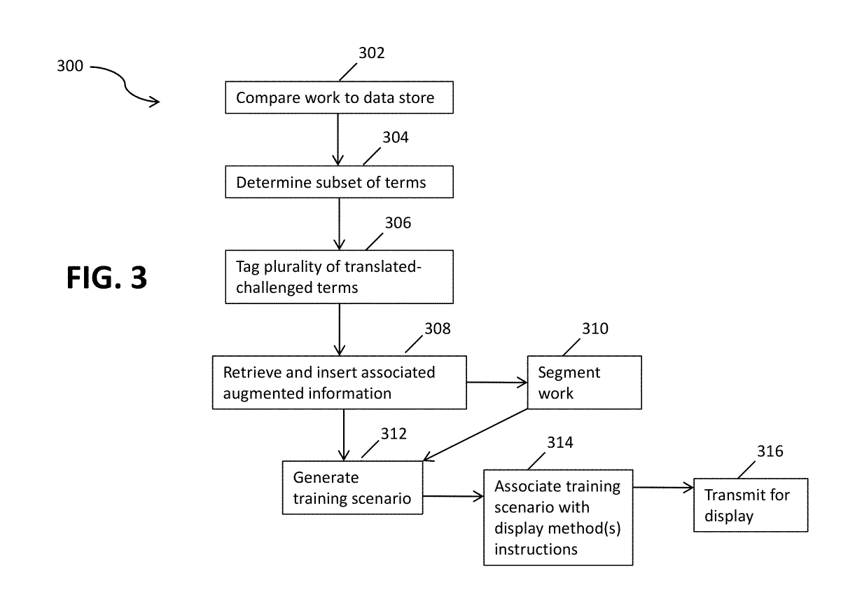

FIG. 3 illustrates a method 300 of generating and transmitting a training scenario. At block 302, an application such as the scenario-building application 106 receives a request to generate a training scenario and analyzes, in response to receiving the request, a work to determine a plurality of translation-challenged terms. This analysis at block 302 may comprise comparing a text of a book, a transcript or voice-to-text transcription of the work to a dictionary data store to determine a first plurality of terms from the work that are present in the data store. At block 304, the application 106 may determine a subset of the terms determined at block 302 which will be deemed translation-challenged terms. This determination of a subset at block 304 may be based, for example, on an attribute of the request received at block 302 such as a predetermined minimum or range of difficulty scores associated with each term of the plurality of translation-challenged terms identified at block 302. Terms in the subset are those terms associated with difficulty scores within that range or above the minimum and may be determined to be translation-challenged terms.

At block 306, the plurality of translation-challenged terms identified at block 304 are tagged in the work. This tagging may be performed in a transcript of the work, in a voice-to-text transcription, in a video track, in an audio track, in a written form of the work including an e-book, or combinations thereof depending upon the format of the work as well as the playback/display format. Tagging the plurality of terms may comprise associating the terms with augmented information and a trigger, wherein the trigger is an electronic tag configured to be read/interpreted by the application (such as the application 122 in FIG. 2) on the display device and may cause the display of augmented information associated with the term in at least one of video, audio, or visual format. The augmented information may be pulled from the dictionary data store discussed herein or from a separate data store of the plurality of data stores 110 in FIG. 1.

In some embodiments, if a translation-challenged term determined at block 304 occurs more than once in the work, every single occurrence may not be tagged and instead a first and/or predetermined number of subsequent number of terms may be tagged in the work or in segments (chapters or other segmented portions) since a user may not need the 10^{th} occurrence of a translation-challenged term to cause the display of augmented information, but may benefit from this display for earlier occurrences of the term. In alternate embodiments, all instances are tagged and the display of the tagged terms and associated augmented information (including but not limited to the translation(s)) and the difficulty adjusted by the user or based on the user's profile as discussed herein.

It is appreciated that the dictionary data store is updated dynamically on a real-time basis and is a live data store in that it is updated when as new terms gain popularity and relevance. At block 308, the application 106 retrieves and inserts or associates augmented information from the dictionary data store for at least some of the tagged plurality of terms. This tag and/or augmented information may be inserted for the first occurrence of a tagged term, or for multiple occurrences of that term in the work. At any of blocks 306 and 308, a trigger may be associated with some or all of the tagged terms, this trigger may cause the display of information, including the augmented information, before, during, or after the occurrence of the tagged terms, in a variety of ways (audio, visual, or combinations) depending upon the work format and display format.

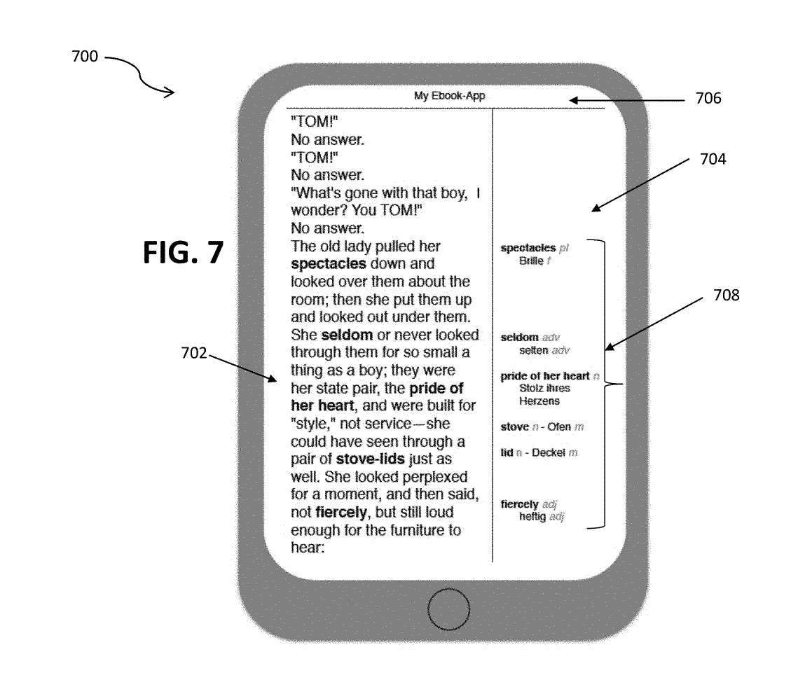

In an embodiment, at block 312, the application 106 generates the training scenario, for example, by mapping the tagged occurrences of translation-challenged terms in any or all of the transcript, voice-to-text transcription, audio track, and video track, and synching the occurrences so that the display of augmented information is triggered before, during, or after the occurrence of the term, depending upon the type (video, audio book, e-book) and/or configuration of the training scenario for display. At block 314, the training scenario is associated with a display method and instructions, for example, a video training scenario for display on a watch may comprise different instructions for display than one intended for display on a tablet, and some may comprise multiple instructions to enable the display on more than one type of display device. The display instructions associated with the training scenario at block 314 are described below in FIGS. 7-12, and may be based in part on the display device and the type of work, e.g., a training scenario generated in the form of a video work at block 312 may be associated with different display instructions than a training scenario generated as an audio work or a text work. At block 316, the application 106 transmits the training scenario to a display device for execution.

In an embodiment, since the dictionary data store is updated dynamically on a real-time basis and is a live data store, a training scenario generated according to the methods discussed herein may comprise a first set of translation-challenged terms when it's generated, and a different set of translation-challenged terms when it is subsequently updated, depending upon the state of the dictionary data store. In some embodiments, a user may receive a notification that a previously-completed training scenario has been updated, for example, because the dictionary has been updated in the time since the training scenario was initially generated and/or completed. The user may then elect to again view the training scenario that has the different set of translation-challenged terms. In some embodiments, the dictionary data store may not only be updated with new terms, but the terms in the dictionary data store may have dynamically adjusted difficulty scores, so a training scenario may have a different set of translation-challenged terms because new terms were added and/or because terms in the dictionary data store have had the difficulty scores associated with those terms updated.

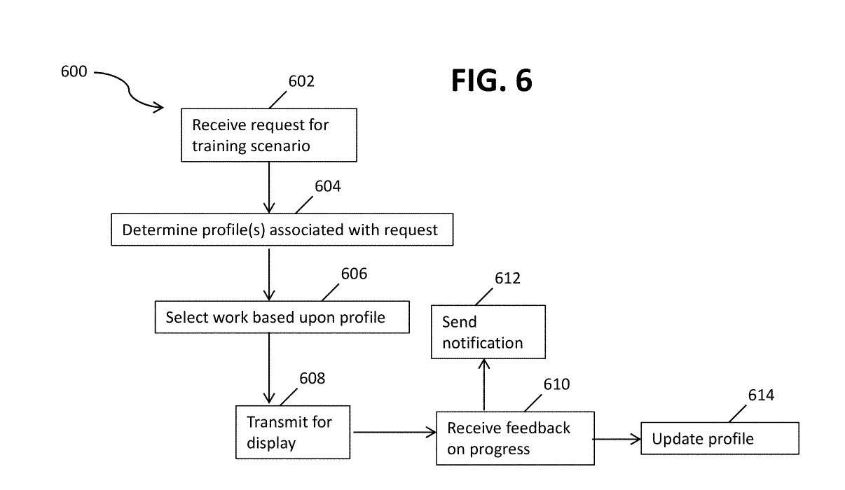

In some embodiments, depending upon the work format, length, and if a request specifying the training scenario was received by the scenario-building application indicating as such, the work may be segmented at block 310. This segmentation may be based off of the work length, the work format, the frequency of tagged words, the distribution of tagged words, the frequency of the first occurrence of tagged words, combinations thereof or other factors as indicated herein. In this embodiment, at block 316, some or all of the segments comprising the training scenario generated at block 312 may be transmitted for display to the display device. In some embodiments, as discussed herein and below in at least FIG. 6, the application 106 may receive feedback from an application on the display device regarding the successful transmission, execution, and status of completion of the transmitted training scenario. This feedback may be employed to update information associated with the training scenario or related training scenarios (e.g., books in a series, chapters of books, movies or television shows comprising one or more episode or work in a series of related works), the dictionary, and/or user profiles.

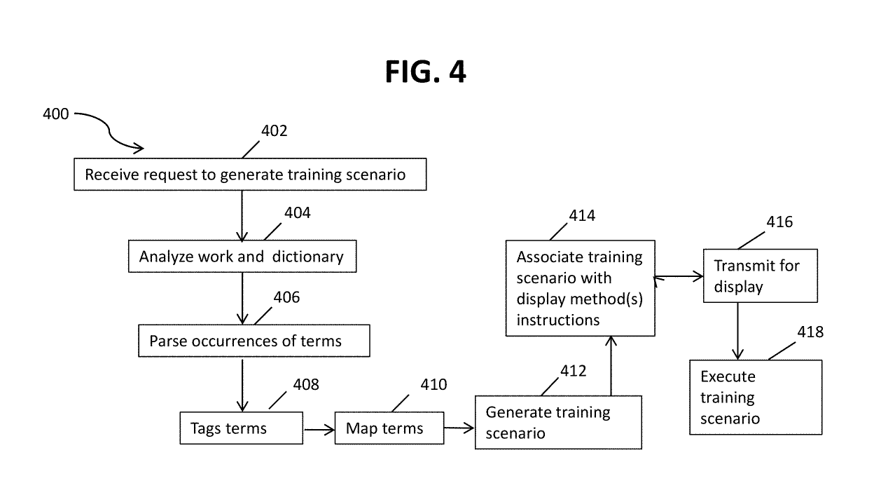

Turning to FIG. 4, a method 400 of automatically generating training scenarios and retrieving and transmitting a training scenario to a display device is illustrated. In the method 400 at block 402, an application such as the scenario-building application 106 in FIG. 1 receives a request to generate a training scenario. At block 404, in response to receiving the request, the application 106 analyzes a work to determine a plurality of translation-challenged terms. This analysis at block 404 may comprise comparing a transcript or voice-to-text transcription of the work to a dictionary data store to determine (1) which terms from the work are present in the data store and (2) which of those terms are indicated as being translation-challenged based, for example, on a predetermined minimum or range for a difficulty score, included in the request at block 402, to generate a plurality of translation-challenged terms. This may be a single step or a multi-step process, depending upon the embodiment and size of the work, and may be done iteratively if, for example, the request received at block 402 comprises a minimum or maximum number of terms to identify.

At block 406, the application 106 may parse the plurality of translation-challenged terms to determine which terms included in this plurality of terms are included both as a single word and as part of a multi-word term so that the application 106 can determine which are actually present as single words and which are present as phrases so that words/terms are not double-tagged. As discussed above, the analysis at block 406 may comprise parsing the occurrence of each of the plurality of translation-challenged terms in what may be an iterative process that is used to determine (1) which single-word terms from the plurality of translation-challenged terms occur in isolation, that is, which are not used in combination with another term that constitutes a phrase also included in the plurality of translation-challenged terms; (2) which multi-word terms occur in combination. That is, if a term comprising a first and a second word is included in the plurality of translation-challenged terms, and at least one of the first or the second words is also included in the plurality, the application 106 determines when the first and/or second words occur alone, in plural form, in different verb tenses, or are otherwise stemmed or inflected terms in contrast to when the term comprising the first and the second words occurs. This enables the application 106 at block 408 to tag the plurality of translation-challenged terms correctly. In one example, if the phrase “beautiful disaster,” and the individual words “beautiful” and “disaster” are included in the plurality of translation-challenged terms based upon the difficulty scores associated with each of the three terms, the application 106 determines if and where “beautiful” and “disaster” occur separately and/or in plural form, in different verb tenses, or are otherwise stemmed or inflected terms in order to tag those at block 408 separately from the tags associated with the terms as used together in a phrase.

In some embodiments, at block 406, the occurrences of the plurality of translation-challenged terms are parsed by the application 106 in an iterative manner that may include first parsing the single-word terms, then the two-word terms, and then larger-number-of-word-terms as well as associated plural forms, verb tenses, or other stemmed or inflected versions of those terms in order to associate the appropriate tag with each term of the plurality of translation-challenged terms at block 408. The tagging at block 408 may occur in any or all of voice-to-text transcription, video track, and/or audio track, depending upon the type of work (e-book, audio book, video work).

In an embodiment, at block 410, the tagged terms in the voice-to-text transcription, video track, and/or audio track are mapped in order to synchronize the sound/text appearance/video display when the training scenario based on the work is generated at block 412 in a similar manner to that discussed above in FIG. 3 with respect to block 312. At blocks 414 and 416, similar to blocks 314 and 316 in FIG. 3, the training scenario is associated with a display method and instructions at block 414 and transmitted at block 416. For example, an e-book training scenario for display on an e-reader may comprise different instructions for display than one intended for display on a wearable device, and some training scenarios may comprise multiple instructions to enable the display on more than one type of display device. The display instructions associated with the training scenario at block 414 are described below in FIGS. 7-12, and may be based in part on the display device and the type of work, e.g., a training scenario generated in the form of a video work at block 416 may be associated with different display instructions than a training scenario generated as an audio work or a text work. At block 420, the application 106 transmits the training scenario to a display device for execution.

In an embodiment, the transmission at block 416 may occur in response to a request for content for the particular training scenario, or a request that may comprise at least one parameter including, a type of work (e-book, audio, video), a display device (tablet, e-reader, wearable technology, laptop, portable computing device, personal computing device, kiosk, personal digital assistant, mobile phone, etc.), an original language, a translated language, a skill level, a topic, a genre, an author, a screenwriter, a songwriter, a display format (which may be related to the display device) or other parameters by which works may be classified and recorded in a data store accessible by the application 106 over the network 112. At block 418, the training scenario may be executed. It is appreciated, in any of the embodiments discussed herein, the training scenario may be executed subsequent to transmission.

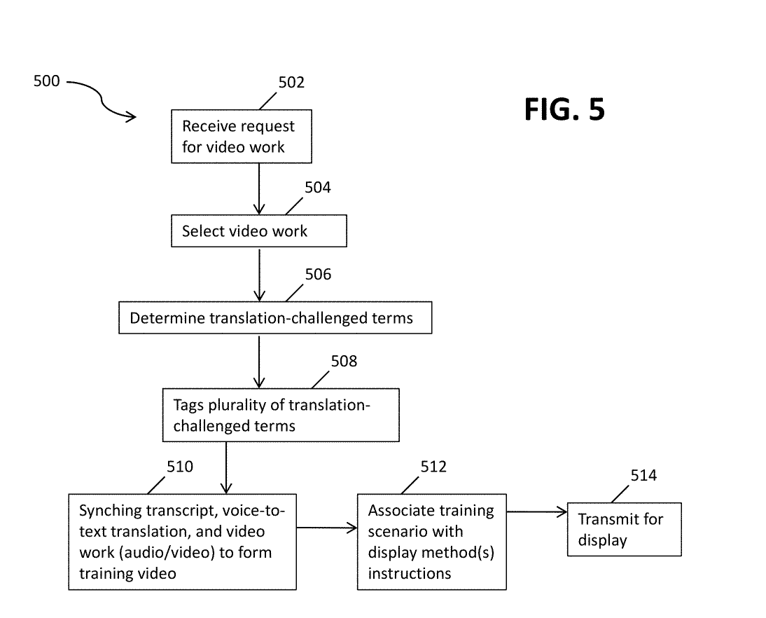

FIG. 5 illustrates a method 500 of generating a video work training scenario. At block 502, a request to generate a video work language-learning training scenario is received. At block 504, a video work is selected based on the request received at block 502, and the determination of terms to be tagged may proceed at block 506 similarly to the determinations discussed above at blocks 306 and 308 in FIG. 3. At block 508, the plurality of translation-challenged terms determined at block 506 to be tagged may be tagged, and a trigger may be associated with some or all of the tagged terms, this trigger may cause the display of information, including the augmented information, before, during, or after the occurrence of the tagged terms, in a variety of ways (audio, visual, or combinations) depending upon the work format and display format. At block 508, in order to enable the generation of the training scenario in the method 500, the translation-challenged terms are tagged in at least two of a transcript of the video work, a voice-to-text transcription, an audio track, and a video track, and the at least two of the transcript, voice-to-text transcription, audio track, and video track are synched at block 510 to generate the training scenario. This synchronization may comprise mapping, and may enable the simultaneous, delayed, or preview display of translation-challenged terms and/or augmented information associated with the translation-challenged terms.

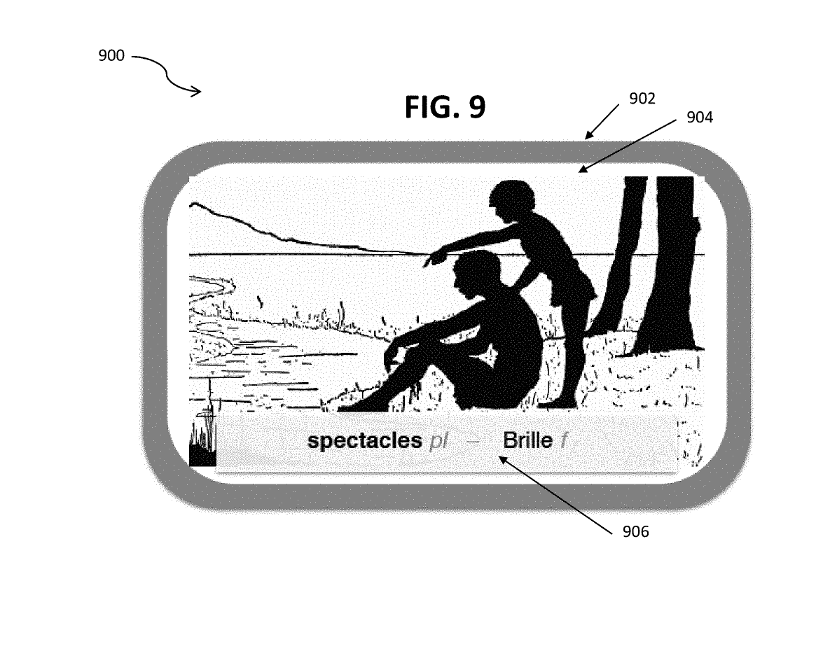

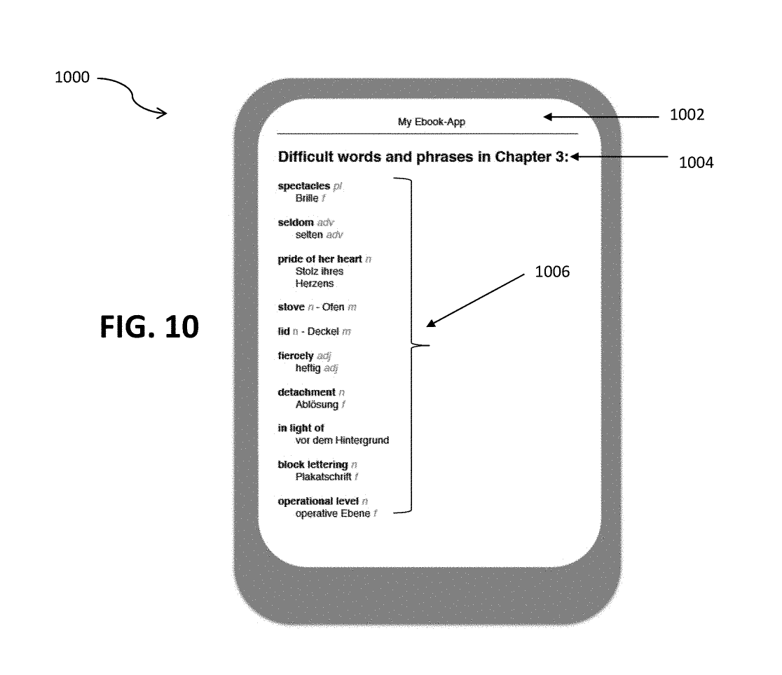

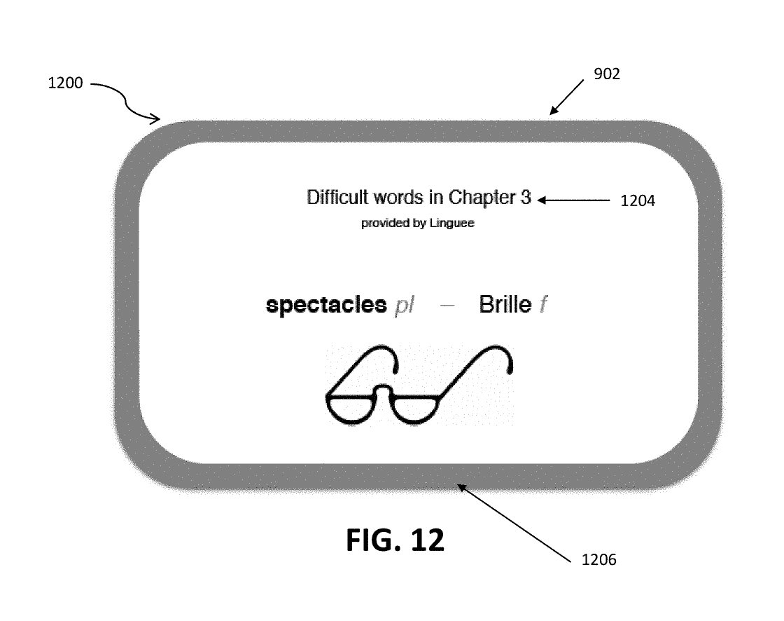

At block 512, similar to block 314 in FIG. 3 and block 414 in FIG. 4, the training scenario is associated with a display method and instructions. For example, a video work training scenario for display on a media-enabled 60″ television in a simultaneous vertical display in preview style may comprise different formatting and instructions for display than one intended for display on a (presumably smaller) wearable device or in a horizontal display or in post-view or concurrent/simultaneous view style as discussed in FIGS. 9 and 12 below. In an embodiment, some training scenarios may comprise multiple instructions to enable the display on more than one type of display device or in more than one type of method (e.g., simultaneous triggering of augmented information when the translation-challenged term occurs as in FIGS. 7-9, or a preview-style as in FIGS. 10-12). The display instructions may be based in part on the display device and the type of work, e.g., a training scenario generated in the form of a video work at block 510 may be associated with different display instructions than a training scenario generated as an audio work or a text work. At block 514, the application 106 transmits the training scenario to a display device for execution.

FIG. 6 is an illustration of a flow chart of a method 600 of generating a training scenario and transmitting it for display based on a user profile. In the method 600, at block 602, an application such as the application 106 in the system 100 in FIG. 1 may receive a request to retrieve a training scenario previously generated using some or all of the systems and methods discussed in FIGS. 1-5. At block 604, the application 106 may determine if the request received at block 602 is associated with a user profile of a plurality of user profiles stored on a data store accessible by the application 106 as discussed above. If, at block 604, the application 106 determines that there is at least one profile associated with the request, the application 106 may select a training scenario that was previously automatically generated, the selection may be based upon at least some attributes of the profile at block 606. Each user profile of the plurality of profiles may comprise attributes such as a name, contact information, age, gender, nationality, a plurality of current skill levels, including skill levels for different languages, genres of works, categories, etc., as well as a plurality of desired skill levels, a native language, and a plurality of subject matter skill levels, where a subject matter skill level may comprise sub-levels for different languages. The plurality of desired skill levels may be set by the user or by a user's supervisor or a system administrator. These desired and current skill levels may be language-specific and associated with a sub-category such as subject matter, genre, category, or other areas where a user would desire specific knowledge. The work on which the training scenario is based may be selected at block 606 based upon at least some information of the plurality of profile information and, in some embodiments, may be additionally based on fields received in the request. As discussed above, these fields may comprise at least one parameter including, a type of work (e-book, audio, video), a display device (tablet, e-reader, wearable technology, laptop, portable computing device, personal computing device, kiosk, personal digital assistant, mobile phone, etc.), an original language, a translated language, a skill level, a topic, a genre, an author, a screenwriter, a songwriter, a display format (which may be related to the display device) or other parameters by which works may be classified and recorded in a data store accessible by the application 106 over the network 112.

At block 608, the application 106 transmits the selected training scenario to a display device for execution. In an embodiment, at block 610, the application 106 may receive feedback on the transmission, execution, and progress of the training scenario which may be individually or collectively referred to as the status of the user's progress or execution of the training scenario. At block 612, a notification may be sent to the user's contact information associated with the profile, and a notification that may be the same as or different in whole or in part from the notification sent to the user may be sent to another party designated in the user's profile such as a supervisor or manager, or to the head of a training department or other party who may be interested in the progress of the user and/or the success of the transmission and execution of the training scenario. At block 614, the application 106 may update some or all attributes of the user's profile based upon the feedback received at block 610. When the user makes subsequent requests for training scenario suggestions, e.g., does not specify a particular scenario to retrieve, the updated profile from block 610 may be employed to select the training scenario for the user.

FIGS. 7-12 discuss various embodiments of work format and display options in detail, and may be combined with and used in any of the system or method embodiments in FIGS. 1-5. FIG. 7 is an illustration of an embodiment of an e-book display 700 of a training scenario generated according to certain embodiments of the present disclosure. As used herein with respect to FIGS. 7-12, the “display” referenced refers to the combination of the device used to display the training scenario as well as to the display of and method of display of tagged/translation-challenged terms, for example, if the tagged terms and/or the associated augmented information are displayed before, after, or simultaneously with the occurrence of the corresponding terms. In the display 700, which may be referred to as a horizontal display or a simultaneous horizontal display, the panels 702 and 704 are displayed next to each other in horizontal panels. In addition, there may be a header field 706 in the display 700. The first panel 702 may comprise the text of the e-book, and the second panel 704 may comprise a plurality of translation-challenged terms and associated augmented information 708 displayed in a synchronized fashion with the text in block 702. In the display 700, the augmented information 708 associated with a term is displayed started on the same line as the term itself, and in alternate embodiments, the augmented information 708 may be displayed but not aligned with the term.

That is, without user intervention or without user intervention other than moving from a first page to a second page, the plurality of tagged terms in the first panel 702, indicated by bold text in this example as “spectacles,” “seldom,” “pride of her heart,” “stove-lids,” and “fiercely,” may be displayed 708 in the second panel 702 simultaneously with the occurrence of those translation-challenged terms in the first panel 702. In one embodiment, this display in the second panel 704 may occur during the first occurrence of a translation-challenged term in the first panel 702, and in alternate embodiments the display in the second panel 704 may comprise second, third, or further occurrences of a particular translation-challenged term. The augmented information 708 is illustrated as the terms translated into one other language, but may, in different embodiments, comprise definitions, synonyms, antonyms, or other augmented information.

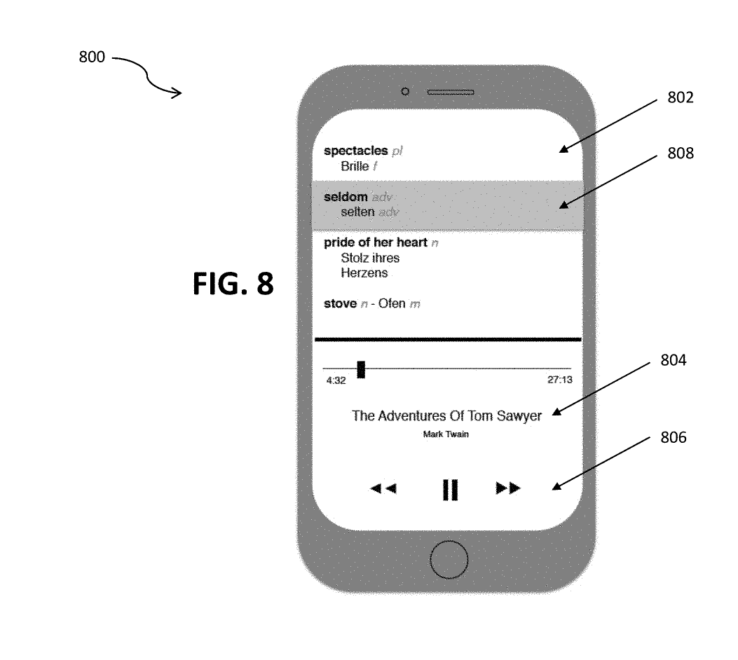

FIG. 8 is an illustration of a display 800 of an audio book training scenario generated according to embodiments of the present disclosure. In the display 800, which may be referred to as a vertical display or a simultaneous vertical display, a first panel 802 may be vertically adjacent to a second panel 804. The first panel 802 may comprise the display of tagged translation-challenged terms based on the recitation of those terms in the audio book due to the triggers associated with the translation-challenged terms during the tagging blocks discussed above. The playback of the audiobook in the display 800 may be controlled by a plurality of audio controls 806. In this embodiment, a user can see the translation-challenged terms displayed in the first panel 802 simultaneously with the recitation of those terms in the audio book, and can pause, rewind, or stop the display and select 808 a particular term further augmented information from the first panel 802. It is appreciated that the second panel 804 may display the title, chapter, author, copyright year(s), or other information associated with the audio book training scenario depending upon the information available and display device capabilities and configuration.

FIG. 9 is an illustration of a display 900 of a video work training scenario generated according to embodiments of the present disclosure. The display 900 may be referred to as a simultaneous vertical display due to the orientation of the display device 902 and the method of presentation. The display device 902 may comprise any device such as a mobile phone, tablet, laptop computer, personal computer, kiosk, television, or other device configured for audio, video, and text display. In the display 900, the training scenario is displayed using at least two panels which may also be referred to as zones. The video itself is displayed in a first panel 904 adjacent to a second panel 906. The second panel 906 displays tagged translation-challenged terms and, in some embodiments, augmented information associated with those terms simultaneously with the occurrence of the term and/or the appearance of the term in the first panel 904. The user may be able to stop, pause, rewind, and fast forward the video work training scenario using controls available on the device 902 and/or those associated with the program used to execute the training scenario.

FIG. 10 is an illustration of an embodiment of an e-book display 1000 of a training scenario generated according to certain embodiments of the present disclosure. In the display 1000 there may be a header field 1002 and a title field 1004 in the display 1000. The display 1000 may comprise a plurality of translation-challenged terms and associated augmented information 1006, in this example, translations and an indication of the type of term (noun, adjective, verb, etc.) is displayed, but in contrast to FIG. 7 where the augmented information 708 is displayed in a synchronized fashion with the text in block 702, the translation-challenged terms and augmented information 1006 are presented prior to the start of a particular section or chapter. In one embodiment, this display of the augmented information and translation-challenged terms 1006 during the first occurrence of a translation-challenged term in the entire e-book, and in alternate embodiments this display of the augmented information and translation-challenged terms 1006 may comprise second, third, or further occurrences of a particular translation-challenged term in an e-book that may occur in the chapter. The augmented information 1006 is illustrated as the terms translated into one other language, but may, in different embodiments, comprise definitions, synonyms, antonyms, or other augmented information. In some embodiments, the augmented information 1006 may comprise the tagged terms being read aloud together with the associated translation, for example, without user interaction beyond initiating the training scenario. This may be employed, for example, by a user who initiates the training scenario while driving. Since the audio book does not require user interaction after the training scenario is initially executed, it may be employed when the user is driving, traveling, or otherwise engaged in activities not conducive to a system that requires user inputs.

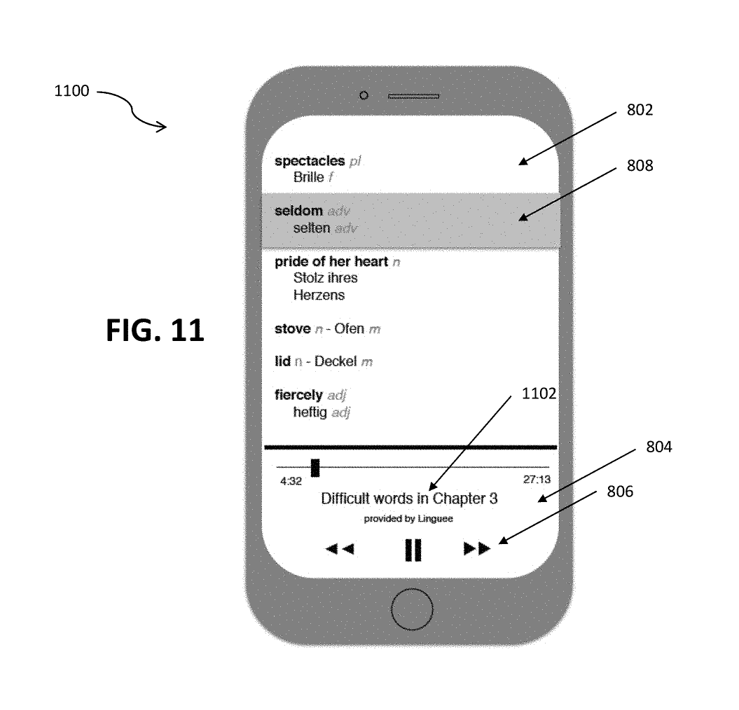

FIG. 11 is an illustration of a display 1100 of an audio book training scenario generated according to embodiments of the present disclosure. In the display 1100, which may be referred to as a vertical display or a simultaneous vertical display, a first panel 802 may be vertically adjacent to a second panel 804. The first panel 802 may comprise the display of tagged translation-challenged terms based on the recitation of those terms in the audio book due to the triggers associated with the translation-challenged terms during the tagging blocks discussed above. The playback of the audiobook in the display 800 may be controlled by a plurality of audio controls 806. In this embodiment, a user can see the translation-challenged terms displayed in the first panel 802 prior to the start of a chapter, as indicated by 1102, or other section where those terms occur in the audio book, and can pause, rewind, or stop the display and select 808 a particular term further augmented information from the first panel 802. It is appreciated that the second panel 804 may display the title, chapter, author, copyright year(s), or other information associated with the audio book training scenario depending upon the information available and display device capabilities and configuration.

FIG. 12 is an illustration of a display 1200 of a video work training scenario generated according to embodiments of the present disclosure. The display 1200 may be referred to as a vertical display due to the orientation of the display device 902. The display device 902 may comprise any device such as a mobile phone, tablet, laptop computer, personal computer, kiosk, television, or other device configured for audio, video, and text display. In the display 1200, the translation-challenged terms and augmented information including a translation and in some embodiments a picture/visual aid may be displayed prior to the start of a scene or other portion of a video. In contrast to FIG. 9, where the translation-challenged term and augmented information are displayed in synchronized fashion with the occurrence of the term in the video, in the display 1200, the translation-challenged terms in a chapter (e.g., in a trilogy or multi-film movie) or a scene 1204 are displayed with their augmented information prior to the scene or chapter playing. This display method may be based upon the tags and/or the display instructions associated with the training scenario as discussed herein. The tagged translation-challenged terms and, in some embodiments, augmented information associated with those terms are displayed 1206 prior to the scene or chapter playing.

A system for generating and transmitting augmented media files, comprising: a server comprising a non-transitory memory, a processor; and a scenario-building application stored on the server, wherein the scenario-building application is in communication with a dictionary data store on a server, wherein the scenario-building application, when executed by the processor: identify a plurality of terms by comparing a work of a plurality of works to a plurality of terms stored in the dictionary data store, wherein the plurality of works comprises audio, video, text, and combinations thereof; determining, based upon a difficulty score associated with each term of the identified plurality of terms, a subset of the plurality of terms, wherein each term of the subset comprises a difficulty score that exceeds a predetermined minimum difficulty score; tags, in the first work, at least some occurrences of the terms of the subset of terms to associate augmented information with the at least some occurrences of the terms of the subset; generates a training scenario comprising the work, and associates the training scenario with a display instruction so that the augmented information associated with each tagged term displays at least one of simultaneously with the occurrence of the term and within a predetermined window of the occurrence of the term; and transmits the training scenario to a display device.

The system further comprising segmenting, by the scenario-building application, the first work into a plurality of segments based upon a number of occurrences of each tagged term of the plurality of tagged terms within predetermined time intervals, wherein the scenario-building application segments the first work into substantially equal size segments, wherein a size of each segment comprises at least one of a number of words, lines, minutes, seconds, combinations of terms, and combinations thereof, wherein the at least one occurrence of each tagged term comprises the first occurrence of each tagged term, wherein each term of the subset of terms comprises at least one word, and wherein the scenario-building application displays the training scenario on at least one of a laptop computer, personal computer, tablet, mobile phone, portable communication device, kiosk, television, or wearable communication device.

In an alternate embodiment, a system for generating and transmitting an augmented media file, comprising: a server comprising a non-transitory memory, and a processor; an application stored on the server, wherein the application is in communication with a dictionary data store on a server, wherein the application, when executed by the processor: determine a plurality of translation-challenged terms by comparing a work to a plurality of terms in the dictionary data store, wherein the plurality of translation-challenged terms comprises single word and multi-word terms associated with a difficulty score above a predetermined minimum; parse the work to determine where single word terms of the plurality of translation-challenged terms occur and where terms of the plurality of translation-challenged terms comprising at least two words occur in the work; tags at least one instance of each term from the subset of terms in the first work, wherein each tag comprises augmented information associated with the tagged term, wherein a first tag associated with a single word term of the plurality of translation-challenged terms comprises augmented information associated with the single word term, wherein a second tag associated with a multi-word term of the plurality of translation-challenged terms comprises different information than the first tag; generates a training scenario comprising the work and the augmented information associated with the plurality of tagged terms; and transmits the training scenario for display.

The system further comprising: wherein the work comprises a text document, a video, an audio track, or combinations thereof, wherein the application generates the training scenario further based upon a plurality of information associated with a user account, wherein the plurality of information comprises a plurality of read works, a plurality of viewed works, a plurality of saved works, wherein the plurality of saved works comprises un-read and un-viewed works, a primary language spoken by the user, a skill level rating associated with the user, or combinations thereof.

In an embodiment, a method of generating and transmitting an augmented media file, comprising: receiving, by an application stored in a non-transitory memory on a first server and executable by a processor, a request for a video work; selecting, by the application, in response to receiving the request, a video work from a plurality of video works stored on a second server based upon at least one characteristic of the request; tagging, by the application, a plurality of terms in the transcript, wherein the tagging a term of the plurality of terms comprises associating the term with augmented information, wherein the augmented information comprises a translation; mapping, by the application, the tagged terms in the transcript to the corresponding occurrence of the tagged terms in at least one of a voice-to text translation of the video work, an audio track of the video work, and the video, wherein, subsequent to mapping, the augmented information is displayed in a synchronized manner with the occurrence of the tagged terms in the video work; and transmitting, by the application, the training video, wherein the transmission comprises a display instruction.

The method further comprising: wherein the at least one characteristic comprises a difficulty score, and displaying at least some of the augmented information using at least one of a selectable indication, synchronized subtitles, subtitles offset from the video of the training video by a predetermined period of time, a break in the training video, or an overlay on the training video, wherein the break in the training video comprises audio, video, text, or combinations thereof, wherein the overlay on the training video comprises audio, video, text, or combinations thereof, wherein the overlay on the training video comprises a pop-up window, wherein displaying at least some of the augmented information prior to displaying the training video—wherein the augmented information further comprises: a definition, a use case, an additional translation, a synonym, an antonym, and an origin, wherein transmitting occurs in response to a different request, wherein the different request comprises at least one characteristic associated with the video work, wherein the at least one characteristic comprises an era, an actor, a director, a producer, a screenwriter, a vocal artist, a title, a category type, a subject type, a genre, a cultural affiliation, and an original language

In an alternate embodiment, a method of generating and transmitting an augmented media file, comprising: determining, by an application stored in a non-transitory memory on a server and executable by a processor, a language skill level associated with a user profile, wherein the user profile comprises a plurality of language skill levels associated with a plurality of different languages; selecting, by the application, based on the determination of the language skill level, a first work of a plurality of works stored on the server; retrieving, by the application, a transcript corresponding to the first work; tagging, by the application, a plurality of terms in the transcript, wherein at least some of the plurality of terms are tagged based upon an analysis of at least the transcript and the language skill level, and wherein each tag comprises augmented information associated with each tagged term; mapping, by the application, the plurality of tagged terms in the transcript with occurrences of the tagged terms in the first work to generate a training scenario, wherein, subsequent to mapping, the augmented information is displayed within a predetermined time interval of the occurrence of the associated tagged term of the plurality of tagged terms; transmitting, by the application, the training scenario, to a display device; updating, by the application, based upon a plurality of information received from the display device, the user profile.

In an embodiment, the method further comprising: wherein the user profile further comprises a plurality of genre skill levels, a plurality of category skill levels, a plurality of desired skill levels, at least one native language, and a plurality of subject matter skill levels, wherein the plurality of desired skill levels is set by the user and comprises a desired skill level in at least one of a category, language, genre, subject matter, or combinations thereof, wherein the user profile further comprises viewed training scenarios, completed training scenarios, saved training scenarios, and recommended training scenarios, wherein the user profile further comprises at least one sub-category associated with each language skill level of the plurality of language skill levels, wherein the at least one sub-category comprises an era, a genre, a subject category, a desired skill level for a language, a desired skill level for a sub-category.

In an alternate embodiment, a method of generating and transmitting an augmented media file, comprising: determining, by an application stored in a non-transitory memory on a server and executable by a processor, a language skill level; selecting, by the application, based on the determination of the language skill level, a first work of a plurality of works stored on the server; retrieving, by the application, a transcript corresponding to the first work; tagging, by the application, a plurality of terms in the transcript, wherein at least some of the plurality of terms are tagged based upon an analysis of at least the transcript and the language skill level, and wherein each tag comprises augmented information associated with each tagged term; mapping, by the application, the plurality of tagged terms in the transcript with occurrences of the tagged terms in the first work to generate a training scenario, wherein, subsequent to mapping, the augmented information is displayed within a predetermined time interval of the occurrence of the associated tagged term of the plurality of tagged terms; transmitting, by the application, the training scenario, to a display device.

The method further comprising: wherein a plurality of user profiles are stored and maintained on the server, wherein each user profile of the plurality of profiles comprises a plurality of language skill levels associated with a plurality of different language; and updating, by the application, based upon a plurality of information received from the display device, a user profile.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A system for generating and delivering an augmented media file, comprising:
a server comprising a non-transitory memory, and a processor;
an application stored on the server, wherein the application is in communication with a dictionary data store on a server, wherein the application, when executed by the processor:
determines a plurality of translation-challenged terms by comparing a work to a plurality of terms in the dictionary data store, wherein the plurality of translation-challenged terms comprises single word and multi-word terms associated with a difficulty score above a predetermined minimum;
parses the work to determine where single word terms of the plurality of translation-challenged terms occur and where terms of the plurality of translation-challenged terms comprising at least two words occur in the work;
tags at least one instance of each term from the plurality of translation-challenged terms in the first work, wherein each tag comprises augmented information associated with the tagged term, wherein a first tag associated with a single word term of the plurality of translation-challenged terms comprises augmented information associated with the single word term;
generates a training scenario comprising the work and the augmented information associated with the plurality of tagged terms; and
transmits the training scenario for display.

2. The system of claim 1, wherein the work comprises a text document, a video, an audio track, or combinations thereof.

3. The system of claim 1, wherein the application generates the training scenario further based upon a plurality of information associated with a user account, wherein the plurality of information comprises a plurality of read works, a plurality of viewed works, a plurality of saved works, wherein the plurality of saved works comprises un-read and un-viewed works, a primary language spoken by the user, a skill level rating associated with the user, or combinations thereof.

4. The system of claim 1 wherein a second tag associated with a multi-word term of the plurality of translation-challenged terms comprises different information than the first tag.

5. A method of generating and delivering an augmented media file, comprising:
selecting, by an application stored in a non-transitory memory on a first server and executable by a processor, a video work from a plurality of video works stored on a second server based upon at least one characteristic of the request;
tagging, by the application, a plurality of terms in the transcript, wherein the tagging a term of the plurality of terms comprises associating the term with augmented information, wherein the augmented information comprises a translation;
mapping, by the application, the tagged terms in the transcript to the corresponding occurrence of the tagged terms in at least one of a voice-to text translation of the video work, an audio track of the video work, and the video, wherein, subsequent to mapping, the augmented information is displayed in a synchronized manner with the occurrence of the tagged terms in the video work; and
generating and transmitting, by the application, based on the mapping, a training video, wherein the transmission comprises a display instruction.

6. The method of claim 5, wherein the at least one characteristic comprises a difficulty score.

7. The method of claim 5, further comprising displaying at least some of the augmented information using at least one of a selectable indication, synchronized subtitles, subtitles offset from the video of the training video by a predetermined period of time, a break in the training video, or an overlay on the training video.

8. The method of claim 7, wherein the break in the training video comprises audio, video, text, or combinations thereof.

9. The method of claim 7, wherein the overlay on the training video comprises audio, video, text, or combinations thereof.

10. The method of claim 7, wherein the overlay on the training video comprises a pop-up window.

11. The method of claim 5, further comprising displaying at least some of the augmented information prior to displaying the training video.

12. The method of claim 5, wherein the augmented information further comprises: a definition, a use case, an additional translation, a synonym, an antonym, and an origin.

13. The method of claim 5, wherein transmitting occurs in response to a different request, wherein the different request comprises at least one characteristic associated with the video work, wherein the at least one characteristic comprises an era, an actor, a director, a producer, a screenwriter, a vocal artist, a title, a category type, a subject type, a genre, a cultural affiliation, and an original language.

14. The method of claim 13, wherein a plurality of user profiles are stored and maintained on the server, wherein each user profile of the plurality of profiles comprises a plurality of language skill levels associated with a plurality of different language.

15. The method of claim 14, further comprising updating, by the application, based upon a plurality of information received from the display device, a user profile.

16. A system for generating and delivering augmented media files, comprising:
a server comprising a non-transitory memory, a processor; and
a scenario-building application stored on the server, wherein the scenario-building application is in communication with a dictionary data store on a server, wherein the scenario-building application, when executed by the processor:
identify a plurality of terms by comparing a work of a plurality of works to a plurality of terms stored in the dictionary data store, wherein the plurality of works comprises audio, video, text, and combinations thereof;
determining, based upon a difficulty score associated with each term of the identified plurality of terms, a subset of the plurality of terms, wherein each term of the subset comprises a difficulty score that exceeds a predetermined minimum difficulty score;
tags, in the first work, at least some occurrences of the terms of the subset of terms to associate augmented information with the at least some occurrences of the terms of the subset;
generates a training scenario comprising the work, and associates the training scenario with a display instruction so that the augmented information associated with each tagged term displays at least one of simultaneously with the occurrence of the term and within a predetermined window of the occurrence of the term; and
transmits the training scenario to a display device.

17. The system of claim 16, wherein the at least one occurrence of each tagged term comprises the first occurrence of each tagged term.

18. The system of claim 16, wherein each term of the subset of terms comprises at least one word.

19. The system of claim 16, wherein the scenario-building application displays the training scenario on at least one of a laptop computer, personal computer, tablet, mobile phone, portable communication device, kiosk, television, or wearable communication device.

20. The system of claim 16, wherein the display device transmits a plurality of feedback to the server subsequent to receiving the transmission.
